(19) United States
(12) Patent Application Publication
(10) Pub. No.: US 2014/0194085 A1
(43) Pub. Date: Jul. 10, 2014

(54) Augmented Location Information for Wireless Communication

(71) Applicant: TeleCommunication Systems, Inc., Annapolis, MD (US)

(72) Inventor: Roger S. Marshall, Auburn, WA (US)

(73) Assignee: TeleCommunication Systems, Inc., Annapolis, MD (US)

(21) Appl. No.: 14/106,030

(22) Filed: Dec. 13, 2013

Related U.S. Application Data
(60) Provisional application No. 61/748,942, filed on Jan. 4, 2013.

(51) Int. Cl. H04W 4/22; H04W 4/04

(52) U.S. Cl. CPC H04W 4/22; H04W 4/043
USPC 455/404.2

(57) ABSTRACT

An Augmented Information server enables inclusion of augmented location data, in relation to an emergency call, expanded beyond that which can be fit into a pre-determined fixed length ALI data response field. A specific type of URI (Uniform Resource Identifier) is included in the ALI data response field, addressing specific augmented location data maintained by the augmented information server, e.g., a map image file, building floor plan, etc. The Augmented Information URI addresses to information accessed by the Augmented Information Server, inserted into an ALI data response field. The augmented, extended or additional location information is stored at a particular web address accessed through a query to the Augmented Information server.

The present application claims priority from U.S. application. Ser. No. 61/748,942, entitled “Augmented Location Information for Wireless Communication”, filed Jan. 4, 2013, the entirety of which is explicitly incorporated herein by reference.

### BACKGROUND OF THE INVENTION

1. Field of the Invention

This invention relates generally to telecommunications. More particularly, it is applicable to emergency services' wireless location technology.

2. Background of Related Art

An emergency number (e.g., “9-1-1”) has been established to have emergency personnel dispatched to a caller's location. Enhanced 9-1-1(“E911”) is defined by the routing of an emergency request to the appropriate Public Safety Answering Point (PSAP) plus the transmission of callback number and location information. Existing E9-1-1Emergency Service standards deliver data associated with an emergency call or caller, within standards defined data elements.

Location determination for 9-1-1calls utilize an Automatic Location Information (ALI) database. The ALI database is used for location retrieval when the call arrives to an appropriate Public Safety Answering Point (PSAP), the ALI database is queried by the PSAP to determine the location of the caller.

Existing automatic location identification (ALI) services provide fixed length data fields to deliver additional location information. But current techniques for delivering additional location information lack the ability to provide this additional data to service consumers (PSAPs). Moreover, existing location delivery interfaces are limited to static provisioned data only, and are restricted to the fixed length data capacity.

### SUMMARY OF THE INVENTION

In accordance with the present invention, a method and apparatus for obtaining augmented location information in relation to an incoming call, comprises querying an automatic location information (ALI) database for basic location information. In response to the ALI query, location information is received relating to a location of a caller, together with a universal resource identifier (URI) indicating an address of augmented location information relating to the location of the caller. A universal resource identifier (URI) de-reference request is initiated to an augmented location information server. In return to the URI de-reference request, augmented location information is received augmenting the location of the caller.

### BRIEF DESCRIPTION OF THE DRAWINGS

Features and advantages of the present invention become apparent to those skilled in the art from the following description with reference to the drawings:

FIG. 1 shows an exemplary Augmented Information Server enabling the provision of augmented location information to a public safety answering point (PSAP), in accordance with the principles of the present invention.

FIG. 2 shows an exemplary augmented location information server entity diagram, in accordance with the principles of the present invention.

### DETAILED DESCRIPTION OF ILLUSTRATIVE EMBODIMENTS

In accordance with the principles of the present invention, the location of an emergency caller can now be augmented with access to extended descriptive location information. Today's wireless access network topologies have evolved to include additional types of antenna systems. These include “small cell” (e.g., picocell, femtocell, and microcell) systems as well as distributed antenna systems (DAS) that spread RF coverage areas out over a greater geographic area or volume (e.g., including multi-floor buildings). Extended descriptive location information provided in accordance with the invention may include, e.g., schematic, description or images relating to the proximate location of any small cells or antenna systems, the floor in a large building, etc., which is not possible in existing emergency 911 systems.

The present invention provides an Augmented Information server 401 technology that enables inclusion of new, extended or additional location data, in relation to an emergency call, expanded beyond that which can be fit into a pre-determined fixed length data field.

The present invention introduces a mechanism and technique to deliver any “Augmented”, extended or additional information to an existing legacy PSAP through the delivery of a specific type of URI (Uniform Resource Identifier), over existing interfaces. The specific type of URI corresponds to descriptive data contained by the Augmented Information Server 401.

The invention leverages the use of existing fixed length data fields, which have restricted capability, to now include an Augmented Information URI 100 address to information accessed by the Augmented Information Server 401, inserted into an ALI data response field. The Augmented Information URI 100 refers to augmented, extended or additional location information stored at a particular web address accessed through a query to the Augmented Information server 401.

The extended location (or other type) emergency information may include, e.g., antenna ID number, floor number, building floor plan information, maps, etc.

The Augmented information URI 100, after being conveyed within the existing location response messaging (e.g., ALI response), is then dereferenced by means of a web browser-based connection back to the Augmented Information Server 401 preferably such that legacy PSAP equipment doesn't require upgrading or replacement.

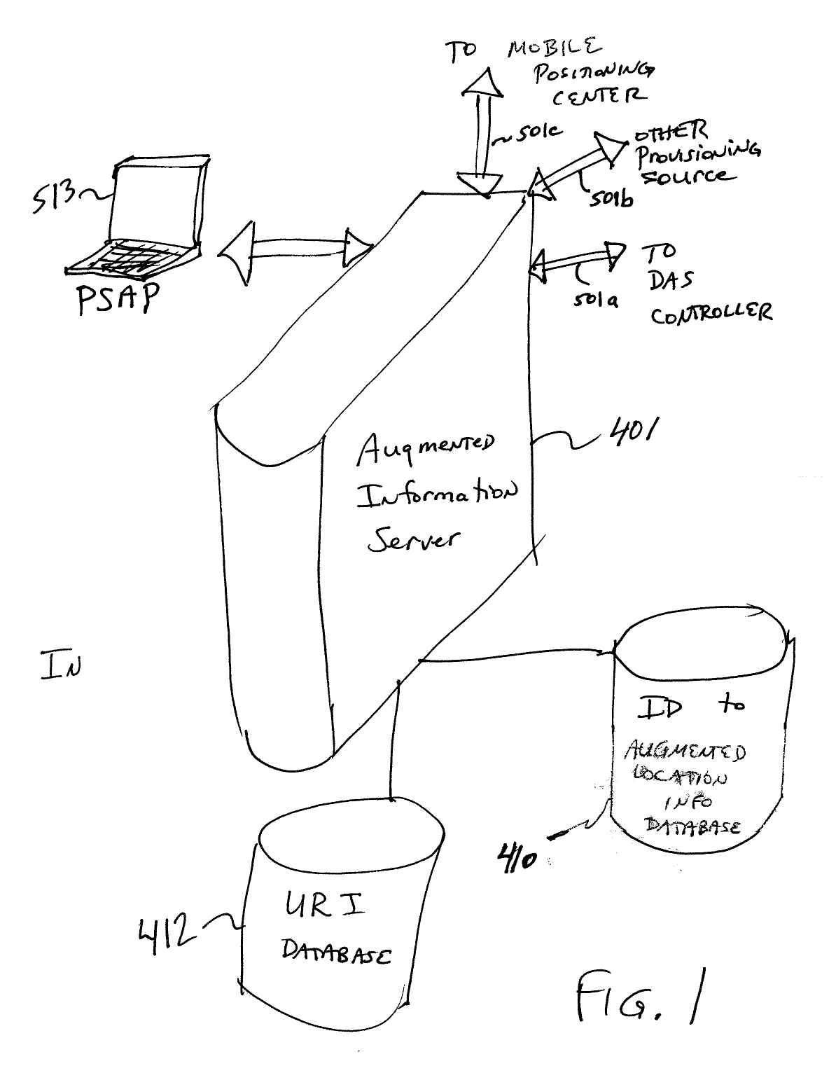

FIG. 1 shows an exemplary Augmented Information Server enabling the provision of augmented location information to a public safety answering point (PSAP), in accordance with the principles of the present invention.

In particular, as shown in FIG. 1, an Augmented Information Server 401 is provisioned over an appropriate interface such as interface 501a to a mobile positioning center (MPC), interface 501b to a suitable provisioning source such as a network server, or interface 501c to a direct attached storage (DAS) controller.

The Augmented Information Server 401 is interfaced over an appropriate network (e.g., wireless network, Internet, etc.) to a relevant public safety answering point (PSAP) terminal 513 responsible for a given emergency call.

Importantly, the Augmented Information Server 401 also includes an ID-to-Augmented Location Information database 410, and a store of available URI (or URL) addresses 412.

The augmented location information mechanism enabled by an Augmented Information Server 401 in accordance with the present invention allows the delivery of detailed augmented location information by accessing or staging the same at a given Universal Resource Indicator (URI) address, and by including that URI within a fixed, legacy data field in response to a location request. The address of the provided URI is de-referenced at the augmented location information server 401, to extract the augmented location information, such as: a supplemental location description; a floor plan; building schematics; network infrastructure elements, etc.

The augmented location information may be dynamic, meaning that it can be constantly changing. Dynamic augmented information is preferably obtained fresh before response to the relevant location request.

The URI address to augmented location information (accessed via the augmented location server 401) is injected within a location response from a legacy ALI interface. The URI address is later de-referenced by the requesting entity, e.g., a public safety answering point (PSAP) 513. The augmented location information obtained from the augmented location information server 401, enables the requesting PSAP 513 to gain additional knowledge and information from within existing legacy systems and interfaces without requiring significant changes. Thus, the present invention provides a mechanism to request, acquire and provide augmented location information that is in addition to conventional location information provided by existing ALI delivery systems. The augmented location information adds location details such as an image file of a floor plan, an image file of a seating chart, network infrastructure details, etc.

The present invention augments otherwise conventional techniques of legacy data delivery systems to include a uniform resource identifier (URI) capable of being used to request and receive additional static & dynamic location information through an IP packet service. In this way, e.g., location details such as a floor plan, a seating chart, network identifiers, etc., can be de-referenced at an augmented location information server.

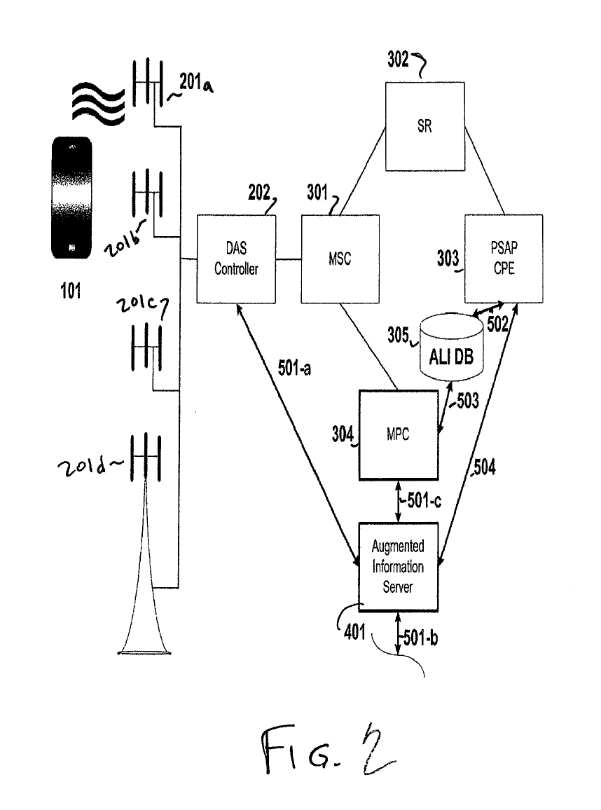

FIG. 2 shows an exemplary basic call sequence of steps for an augmented location information server, in accordance with the principles of the present invention.

In particular, as shown in FIG. 2, a given mobile device 101 communicates with a wireless network via a specific receiving antenna 201a. A DAS controller 202 receives the communication, and is itself in communication with a mobile switching center (MSC) 301. Location is obtained from an automatic location identification (ALI) database 305, which receives location from, e.g., a mobile positioning center (MPC) 304. Importantly, additional information is provided via an augmented location information server 401. The mobile switching center (MSC) 301 is in communication with a selective router 302, which routes messages to an appropriate public safety answering point (PSAP)/customer premises equipment (CPE) 303.

A call flow is now described with reference to FIG. 2.

In particular, at first an emergency E9-1-1wireless call is initiated by a user from a mobile device 101.

The call signaling traverses one of several distributed array antennas 201a, 201b, 201c, 201d (collectively 201) specific to a certain floor of, e.g., a hi-rise building (e.g., Description, “floor 4, Antenna ID. #DA1-4”)

The call signals to and through the DAS controller element 202, including the DAS identifying information for the specific antenna 201a that is being used for the call.

The DAS controller 202 forwards the signaling, including the DAS ID information #DA1-4 (in our example), to the mobile switching center 301 to be emergency routed.

The mobile switching center (MSC) 301 sends signaling to the mobile positioning center (MPC) 304, requesting routing information.

The mobile positioning center (MPC) 304 queries a database that associates additional data with an augmented information URI and the DAS ID #DA1-4, and sends the augmented information to the augmented location information server 401 for staging of the augmented information.

The mobile positioning center (MPC) 304 returns routing information to the mobile switching center (MSC) 301.

The mobile switching center (MSC) 301 sends the call signaling and routing information (e.g., ESRK) to the selective router (SR) 302 according to standard E9-1-1practices.

The selective router (SR) 302 sends the call signaling and routing information (e.g., ESRK) to the PSAP customer premises equipment (CPE) 303.

The PSAP customer premises equipment (CPE) 303 uses the routing information (e.g., ESRK) over the conventional E9-1-1ALI interface 502 to query for basic location information.

The ALI database 305 in turn, queries the mobile positioning center (MPC) 304 for basic location information.

The mobile positioning center (MPC) 304 returns basic location information along with the augmented information URI that was staged for the given antenna 201a being used, to the ALI database 305 over the ALI interface 503.

This basic location information together with the retrieved augmented information URI is then returned to the PSAP customer premises equipment (CPE) 303 through the legacy ALI database 305, over the conventional E9-1-1ALI interface 502.

Simultaneous with, or subsequent to the step of the PSAP CPE 303 using the routing information over the conventional E9-1-1ALI interface 502 to query for basic location information, the PSAP customer premises equipment (CPE) 303 (e.g., an HTTPS browser client) initiates a URI de-reference request to the augmented location information server 401 over an interface 504 between the PSAP customer premises equipment (CPE) 303 and the augmented location information server 401.

Then the augmented location information server 401 returns augmented location information to the PSAP customer premises equipment (CPE) 303 including the information related to the specific DAS Antenna 201a over which the emergency call was initiated, (e.g., “DAS Antenna ID #DA1-4, Floor 4”).

Interfaces 501-a, 501-b, and 501-c represent different provisioning input capabilities from a variety of information sources; the given example call sequence utilizes interface 501-c, that is a direct signaling interchange between the mobile positioning center (MPC) 304 and the augmented location information server 401.

In accordance with the principles of the present invention, ahead of a given emergency call, a wireless service provider identifies additional location-based information that may be required or otherwise utilized by a PSAP. The wireless service provider works with a relevant application service provider to create a URI, and to provision that URI into the ALI data provider (e.g., a mobile positioning center (MPC)).

Then, at the time of an emergency call initiated by a given mobile device, the MPC service provider delivers automatic location information (ALI) location-based information, along with a URI, within the delivery of ALI data. The relevant PSAP receives the delivered ALI location information along with the additional location URI, and is then able to use the URI through a suitable browser, to de-reference for additional location information. The dereferencing may be performed, e.g., within a browser session, if an HTTP/HTTPS URI, etc.

While an exemplary E9-1-1mobile use case is shown and described, the present invention applies equally to VoIP, VoLTE, and SMS and OTT Text-to-9-1-1as well.

While the existing legacy PSAP 303 wouldn't necessarily need to have any upgraded or replaced equipment, it would require a web browser application running on a computer host that had network access to the augmented location information server 401 to which the augmented information URI (AI-URI) points to.

A PSAP may decide to access additional service capabilities that may now be offered as additional web services (e.g., HTTP based services) with no additional equipment necessary. Example application services that can be easily leveraged in this manner include SMS-to-9-1-1, Text-to-9-1-1, Video Services, etc.

Using the present invention, PSAPs can determine to evolve all the traditionally supplied ALI information over to a web services interface alone, leaving only the exchange of emergency services routing key or the like (ESxK) for URI within the legacy ALI interface. This option appeals to PSAPs that want to take advantage of a richer dataset, higher retention and security controls, and more capable customer premises equipment (CPE) systems.

The present invention provides an easy to implement, transitional step, enabling the provision of additional data for existing (legacy) PSAPs through the use of NG9-1-1type application services, yet delivered through existing legacy interfaces.

A benefit of the present invention is that carriers can provide, and PSAPs can receive, augmented location information, such as a specific antenna ID number, and plain text description (e.g., “DA1-4, Floor 4”) for statically deployed antenna systems without provisioning a static text string into the existing interface data field, but through the use of a dereferenceable URI. Not only can this supply static information, but it can also provide dynamic information supplied by the network, such as one of several microcells aboard a moving train as a caller is moving from car to car, and where the serving cell roams between fixed cell sites along the train's path.

The invention has applicability to PSAPs, wireless service providers, wireline (LEC/CLEC) service providers, VoIP service providers, and application service providers.

While the invention has been described with reference to the exemplary embodiments thereof, those skilled in the art will be able to make various modifications to the described embodiments of the invention without departing from the true spirit and scope of the invention.

What is claimed is:

1. A method of obtaining augmented location information in relation to an incoming call, comprising:
querying an automatic location information (ALI) database for basic location information;
receiving, in response to said ALI query, location information relating to a location of a caller, together with a universal resource indicator (URI) indicating an address of augmented location information relating to said location of said caller;
initiating a universal resource indicator (URI) de-reference request to an augmented location information server; and
receiving, in return to said URI de-reference request, augmented location information augmenting said location of said caller.

2. The method of obtaining augmented location information in relation to an incoming call according to claim 1, wherein:
said PSAP initiates said URI de-reference request to said augmented location information server.

3. The method of obtaining augmented location information in relation to an incoming call according to claim 1, wherein:
said URI de-reference request is performed via an HTTPS browser client.

4. The method of obtaining augmented location information in relation to an incoming call according to claim 1, wherein:
said URI de-reference request is performed via an HTTP browser client.

5. The method of obtaining augmented location information in relation to an incoming call according to claim 1, wherein:
said augmented location information comprises a map.

6. The method of obtaining augmented location information in relation to an incoming call according to claim 1, wherein:
said augmented location information comprises an image file.

7. The method of obtaining augmented location information in relation to an incoming call according to claim 1, wherein:
said augmented location information comprises a specific DAS antenna description over which a related emergency call was initiated.

8. The method of obtaining augmented location information in relation to an incoming call according to claim 1, wherein:
said augmented location information comprises a building floor number.

9. The method of obtaining augmented location information in relation to an incoming call according to claim 1, wherein:
said augmented location information comprises a building room number.

10. The method of obtaining augmented location information in relation to an incoming call according to claim 1, wherein:
said incoming call is an emergency call.

11. The method of obtaining augmented location information in relation to an incoming call according to claim 1, wherein:
wherein a PSAP queries said ALI database.

12. Apparatus for obtaining augmented location information in relation to an incoming call, comprising:
means for querying an automatic location information (ALI) database for basic location information;
means for receiving, in response to said ALI query, location information relating to a location of a caller, together with a universal resource indicator (URI) indicating an address of augmented location information relating to said location of said caller;
means for initiating a universal resource indicator (URI) de-reference request to an augmented location information server; and
means for receiving, in return to said URI de-reference request, augmented location information augmenting said location of said caller.

13. The apparatus for obtaining augmented location information in relation to an incoming call according to claim 12, wherein:
said PSAP initiates said URI de-reference request to said augmented location information server.

14. The apparatus for obtaining augmented location information in relation to an incoming call according to claim 12, wherein:
said URI de-reference request is performed via an HTTPS browser client.

15. The apparatus for obtaining augmented location information in relation to an incoming call according to claim 12, wherein:
said URI de-reference request is performed via an HTTP browser client.

16. The apparatus for obtaining augmented location information in relation to an incoming call according to claim 12, wherein:
said augmented location information comprises a map.

17. The apparatus for obtaining augmented location information in relation to an incoming call according to claim 12, wherein:
said augmented location information comprises an image file.

18. The apparatus for obtaining augmented location information in relation to an incoming call according to claim 12, wherein:
said augmented location information comprises a specific DAS antenna description over which a related emergency call was initiated.

19. The apparatus for obtaining augmented location information in relation to an incoming call according to claim 12, wherein:
said augmented location information comprises a building floor number.

20. The apparatus for obtaining augmented location information in relation to an incoming call according to claim 12, wherein:
said augmented location information comprises a building room number.

21. The apparatus for obtaining augmented location information in relation to an incoming call according to claim 12, wherein:
said incoming call is an emergency call.

22. The apparatus for obtaining augmented location information in relation to an incoming call according to claim 12, wherein:
wherein a PSAP queries said ALI database.
